(19) United States
(12) Patent Application Publication
(10) Pub. No.: US 2004/0212678 A1
(43) Pub. Date: Oct. 28, 2004

(54) Low power motion detection system

(76) Inventors: Peter David Cooper, Grays Point (AU); John S. Wenstrand, Menlo Park, CA (US)

Correspondence Address: AGILENT TECHNOLOGIES, INC., Legal Department, DL429, Intellectual Property Administration, P.O. Box 7599, Loveland, CO, 80537-0599, US

(21) Appl. No.: 10/423,656

(22) Filed: Apr. 25, 2003

(51) Int. Cl. H04N 7/18

(52) U.S. Cl. 348/155; 348/143

(57) ABSTRACT

A low power motion detection system includes a low-resolution image sensor having a normal mode and a low power consumption sleep mode. The sensor is configured to periodically exit the sleep mode and enter the normal mode, capture a low-resolution image of a scene in the normal mode, and then return to the sleep mode. The system includes a controller for determining whether motion has occurred based on images captured by the sensor.

### THE FIELD OF THE INVENTION

This invention relates generally to motion detectors, and relates more particularly to a low power motion detection system.

### BACKGROUND OF THE INVENTION

Existing devices for detecting motion include passive infrared (PIR) motion detectors. PIR motion detectors detect radiated energy, such as energy radiated by a human or animal. PIR motion detection devices typically cost about $20, and usually draw ten to twenty milliamps at twelve volts (i.e., 120-240 milliwatts (mW)). A typical nine-volt battery offers 565 milliamp hours (mAH), which would provide about five hours of continual operation for such PIR devices—a relatively short duration.

Some security camera systems use PIR motion detectors to detect motion and trigger a security camera. For video security camera systems, it is desirable to capture high-resolution images for various reasons, such as to be able to recognize the faces of individuals appearing in the images. Security camera systems that capture high-resolution images typically consume relatively large amounts of power, and are usually not battery-powered, or if they are battery-powered, the battery life is relatively short due to the large power consumption. Many security camera systems are also configured to record at all times, rather than only when there is activity, which wastes video tape or digital recording space.

### SUMMARY OF THE INVENTION

One form of the present invention provides a low power motion detection system including a low-resolution image sensor having a normal mode and a low power consumption sleep mode. The sensor is configured to periodically exit the sleep mode and enter the normal mode, capture a low-resolution image of a scene in the normal mode, and then return to the sleep mode. The system includes a controller for determining whether motion has occurred based on images captured by the sensor.

### BRIEF DESCRIPTION OF THE DRAWINGS

FIG. 1 is a block diagram illustrating major components of a low power motion detector according to one embodiment of the present invention.

FIG. 2 is a block diagram illustrating major components of the image acquisition system shown in FIG. 1 according to one embodiment of the present invention.

FIG. 3 is a flow diagram illustrating a method for detecting motion based on successive images according to one embodiment of the present invention.

FIG. 4 is a flow diagram illustrating a method for detecting motion based on non-successive images according to one embodiment of the present invention.

FIG. 5 is a block diagram illustrating a low power, wireless event detection system according to one embodiment of the present invention.

FIG. 6 is a block diagram illustrating major components of the wireless motion detector shown in FIG. 5 according to one embodiment of the present invention.

FIG. 7 is a block diagram illustrating a low power, wireless event detection and camera system according to one embodiment of the present invention.

FIG. 8 is a block diagram illustrating major components of the wireless motion detection and camera system shown in FIG. 7 according to one embodiment of the present invention.

FIG. 9 is a block diagram illustrating major components of the wireless motion detection and camera system shown in FIG. 7 according to a second embodiment of the present invention.

FIG. 10 is a block diagram illustrating major components of the wireless motion detection and camera system shown in FIG. 7 according to a third embodiment of the present invention.

FIG. 11 is a diagram illustrating a motion detecting control switch apparatus according to one embodiment of the present invention.

FIG. 12 is a block diagram illustrating major components of the control switch apparatus shown in FIG. 11 according to one embodiment of the present invention.

FIG. 13 is a block diagram illustrating major components of the motion detection apparatus shown in FIG. 12 according to one embodiment of the present invention.

FIG. 14 is a flow diagram illustrating a method for controlling a light with the control switch apparatus shown in FIG. 11 according to one embodiment of the present invention.

### DESCRIPTION OF THE PREFERRED EMBODIMENTS

In the following detailed description of the preferred embodiments, reference is made to the accompanying drawings, which form a part hereof, and in which is shown by way of illustration specific embodiments in which the invention may be practiced. It is to be understood that other embodiments may be utilized and structural or logical changes may be made without departing from the scope of the present invention. The following detailed description, therefore, is not to be taken in a limiting sense, and the scope of the present invention is defined by the appended claims.

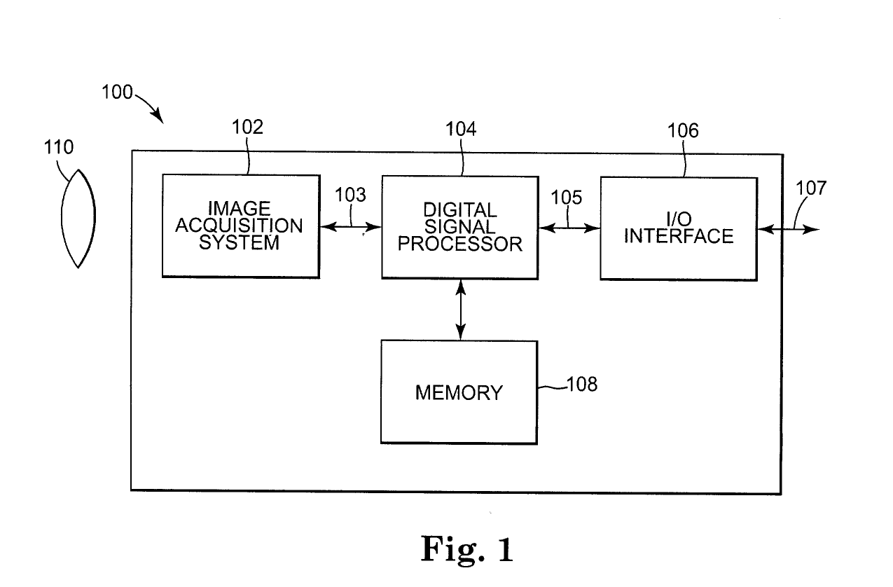

FIG. 1 is a block diagram illustrating major components of a low power motion detector 100 according to one embodiment of the present invention. Motion detector 100 includes image acquisition system 102, digital signal processor (controller) 104, input/output (I/O) interface 106, memory 108, and lens 110.

In one embodiment, image acquisition system 102 includes a low-resolution CMOS image sensor with less than 1000 pixels (e.g., a 16×16 pixel sensor). In operation, according to one embodiment, optical images within the field of view of motion detector 100 are directed by lens 110 onto the CMOS image sensor of image acquisition system 102. The viewing angle of motion detector 100 is easily modified by changing the optics of the detector 100. Image acquisition system 102 continually captures images at a programmed frame rate (e.g., one frame per second), digitizes the captured images, and provides the digital images to digital signal processor 104 via communication link 103. Digital signal processor 104 stores received digital images (frames) in memory 108. In one embodiment, digital signal processor 104 compares captured frames to each other to identify whether motion has occurred, and outputs motion flags to I/O interface 106 via communication link 105 when motion is detected. The motion flags are output by I/O interface 106 via communication link 107.

Digital signal processor 104 may use a variety of different techniques for determining whether motion has occurred. Some example motion detection techniques used by embodiments of digital signal processor 104 are described below. The motion detection techniques are generally directed at identifying changes between two images, quantifying the amount of change, and comparing the amount of change to a threshold value to determine whether the change is significant enough to generate a motion flag. In one embodiment, the threshold values used by digital signal processor 104 are user programmable, and may be set on a pixel by pixel basis, or for entire frames, depending upon the particular motion detection technique used. For example, if one or two pixels repeatedly result in the false generation of motion flags, the threshold values for those specific pixels can be set higher.

In one embodiment, motion detection is accomplished by digital signal processor 104 by comparing a newly captured sample frame with a previously captured reference frame. In one form of the invention, digital signal processor 104 calculates an average intensity value for each sample frame, and compares the average intensity value to an average intensity value calculated for a previously captured reference frame. If the difference between the average intensity values for the two frames is greater than a predetermined threshold, digital signal processor 104 outputs a motion flag. The value chosen for the threshold depends upon the desired sensitivity of motion detection. By using a relatively large threshold value, motion flags will only be generated for large movements, such as movements of a human, and motion flags will not be generated for smaller movements, such as those of small animals.

In another embodiment, motion detection is accomplished by digital signal processor 104 by comparing a sample frame with a previously captured reference frame on a pixel by pixel basis to determine whether there has been any change between the two frames. In one form of the invention, digital signal processor 104 performs a logical Exclusive-Or (XOR) operation on the pixels of the two frames being compared to identify pixels that have changed. If a pixel in one frame is the same as a corresponding pixel in the second frame, the XOR operation will result in a logical “0” for that pixel. If a pixel in one frame is different than a corresponding pixel in the second frame, the XOR operation will result in a logical “1” for that pixel. In one embodiment, if the number of pixels that have changed from one frame to the next exceeds a predetermined threshold value, digital signal processor 104 outputs a motion flag. And if no pixels have changed, or if the number of pixels that have changed is less than the threshold value, digital signal processor 104 does not output a motion flag.

In yet another embodiment, motion detection is accomplished by digital signal processor 104 by performing various trial shifts or translations for each frame, where all of the pixels in the frame are shifted in a certain direction. Each of the shifted frames and the original (unshifted) frame are individually correlated with a previously captured reference frame. If the original (unshifted) frame provides the best correlation with the reference frame, no motion flag is generated. If one of the shifted frames provides the best correlation with the reference frame, digital signal processor 104 outputs a motion flag.

Although various techniques for performing motion detection based on captured images have been described above, it will be understood by persons of ordinary skill in the art that further embodiments of the present invention may use other motion detection techniques.

In one embodiment, motion detector 100 is implemented with an Agilent low-power CMOS image sensor, such as the Agilent ADNS-2020 image sensor. In one embodiment, the number of frames captured per second by motion detector 100 is programmable, and motion detector 100 can be programmed to capture any number of frames per second, up to several thousand frames per second.

In one embodiment, motion detector 100 is configured to capture one frame per second. In one form of the invention, motion detector 100 is operated primarily in a low power consumption sleep mode, and includes an internal timer (not shown) to wake the detector 100 once per second. Each time that motion detector 100 wakes up, the detector 100 captures another image, determines whether motion has occurred, and then goes back into sleep mode if no motion has occurred. In one form of the invention, during each second of operation, motion detector 100 is in sleep mode for about nine tenths of a second, and then wakes up for about one tenth of a second to capture an image and compare the image to a previously captured image to determine whether motion has occurred. Operating motion detector 100 at a low frame rate and in the sleep mode in this manner provides significant power savings. In another embodiment, motion detector 100 is configured to capture more or less than one frame per second.

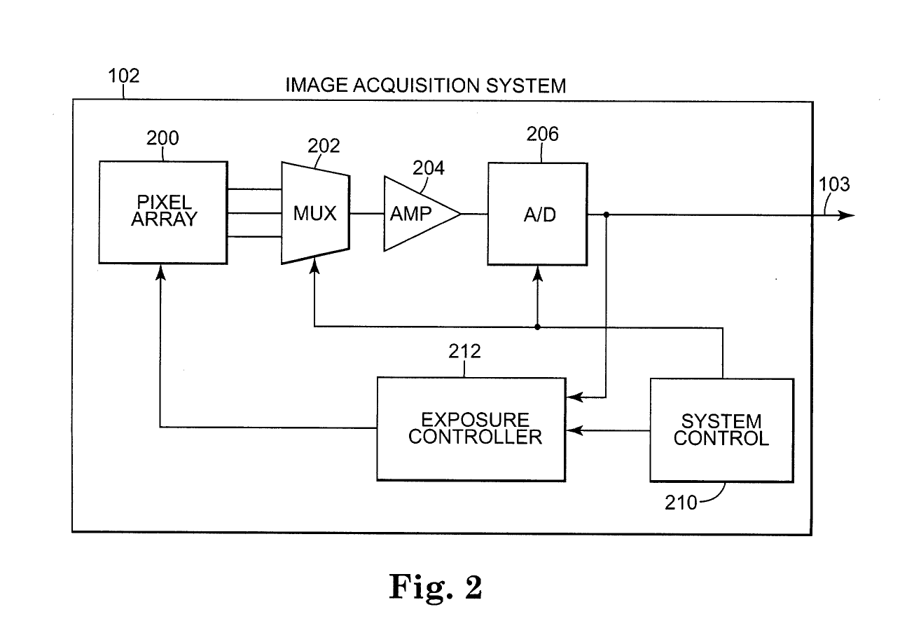

FIG. 2 is a block diagram illustrating major components of the image acquisition system 102 shown in FIG. 1 according to one embodiment of the present invention. Image acquisition system 102 includes pixel array 200, multiplexer (MUX) 202, amplifier 204, analog to digital (A/D) converter 206, system controller 210, and exposure controller 212. In one embodiment, the operation of image acquisition system 102 is primarily controlled by system controller 210, which is coupled to multiplexer 202, A/D converter 206, and exposure controller 212. In operation, according to one embodiment, received light is directed by lens 110 (FIG. 1) onto light sensitive photo detectors within pixel array 200.

Pixel array 200 includes a plurality of pixel circuits (pixels). In one form of the invention, pixel array 200 is a CMOS pixel array, which includes a photo sensor (e.g., photo diode) and a plurality of CMOS transistors for each pixel in the array 200. In one embodiment, the pixels in array 200 are relatively large, such as about 0.02 by 0.02 inches. The use of a CMOS pixel array with a relatively small number of large size pixels results in a low power consumption.

During a charge accumulation time, charge accumulates within each photo detector in array 200, creating a voltage that is related to the intensity of light incident on the photo detector. At the end of the charge accumulation time, multiplexer 202 connects each photo detector in turn to amplifier 204 and A/D converter 206, to amplify and convert the voltage from each photo detector to a digital value. The photo detectors are then discharged, so that the charging process can be repeated.

Based on the level of voltage from each photo detector, A/D converter 206 generates a digital value of a suitable resolution (e.g., eight bits) indicative of the level of voltage. The digital values represent digital images or digital representations of the optical images directed by lens 110 onto pixel array 200. The digital values are output by AID converter 206 to digital signal processor 104 (FIG. 1) via communication link 103.

In addition to providing digital images to digital signal processor 104, in one embodiment, A/D converter 206 also outputs digital image data to exposure controller 212. Exposure controller 212 helps to ensure that successive images have a similar exposure, and helps to prevent the digital values from becoming saturated to one value. Controller 212 checks the values of digital image data and determines whether there are too many minimum values or too many maximum values. If there are too many minimum values, controller 212 increases the charge accumulation time of pixel array 200. If there are too many maximum values, controller 212 decreases the charge accumulation time of pixel array 200.

In one form of the invention, a subset of the pixels in array 200 are “masked out”, or programmed to be inactive. For example, the images directed onto some of the pixels in array 200 may be from an area where motion is unlikely to occur (e.g., a ceiling in a room). By programming a subset of the pixels in array 200 to be inactive, and only reading the active pixels, further power savings are provided. In another embodiment, the outputs of all of the pixels in array 200 are digitized by A/D converter 206, and pixel data corresponding to areas that are not of interest are not processed, or are ignored, by digital signal processor 104 (FIG. 1).

It will be understood by a person of ordinary skill in the art that functions performed by motion detector 100 may be implemented in hardware, software, firmware, or any combination thereof. The implementation may be via a microprocessor, programmable logic device, or state machine. Components of the present invention may reside in software on one or more computer-readable mediums. The term computer-readable medium as used herein is defined to include any kind of memory, volatile or non-volatile, such as floppy disks, hard disks, CD-ROMs, flash memory, read-only memory (ROM), and random access memory.

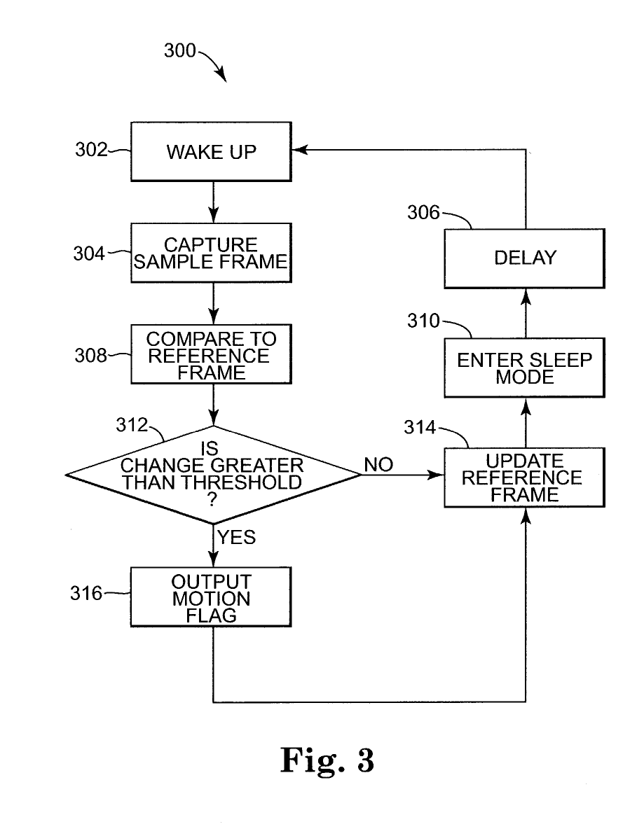

FIG. 3 is a flow diagram illustrating a method 300 for detecting motion based on successive images according to one embodiment of the present invention. In one embodiment, motion detector 100 is configured to perform method 300. In step 302 of method 300, motion detector 100 wakes up from the sleep mode. In step 304, image acquisition system 102 of motion detector 100 captures a sample frame of a scene within the field of view of motion detector 100. In step 308, digital signal processor 104 compares the captured sample frame to a previously captured reference frame, which is stored in memory 108. In step 312, digital signal processor 104 determines whether the differences or changes between the sample frame and the reference frame are greater than a threshold level of change (indicating that a relatively significant motion has occurred). If it is determined in step 312 that the change is not greater than the threshold, the method moves to step 314 (described below).

If it is determined in step 312 that the change is greater than the threshold, in step 316, digital signal processor 104 outputs a motion flag through I/O interface 106, and the method moves to step 314. In step 314, digital signal processor 104 updates the reference frame by replacing the current reference frame stored in memory 108 with the sample frame captured in step 304. Thus, the sample frame captured in step 304 becomes the next reference frame for the next iteration of method 300.

In step 310, motion detector 100 returns to the sleep mode. In step 306, motion detector pauses or delays for a period of time before capturing the next sample frame. In one embodiment, the delay period is slightly less than one second (e.g., about nine tenths of a second). The method then returns to step 302, and the process is repeated.

In the embodiment shown in FIG. 3 and described above, the reference frame is updated (in step 314) during each iteration of method 300, regardless of the outcome of the determination made in step 312. Thus, the frames that are compared in step 308 are successive frames (i.e., there are no intervening frames between the reference frame and the sample frame).

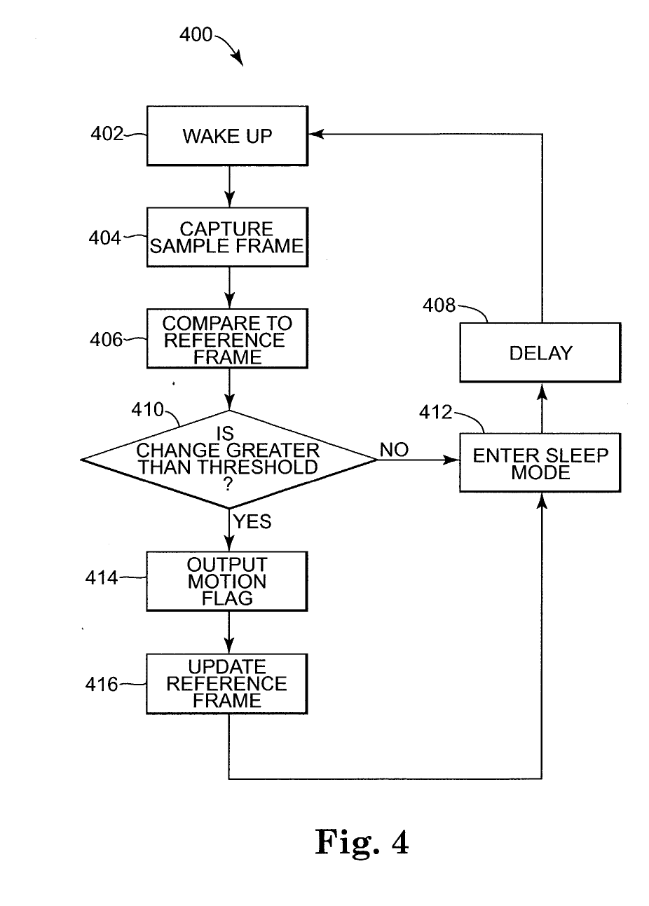

FIG. 4 is a flow diagram illustrating a method 400 for detecting motion based on non-successive images according to one embodiment of the present invention. In one embodiment, motion detector 100 is configured to perform method 400. In step 402 of method 400, motion detector 100 wakes up from the sleep mode. In step 404, image acquisition system 102 of motion detector 100 captures a sample frame of a scene within the field of view of motion detector 100. In step 406, digital signal processor 104 compares the captured sample frame to a previously captured reference frame, which is stored in memory 108. In step 410, digital signal processor 104 determines whether the differences or changes between the sample frame and the reference frame are greater than a threshold level of change (indicating that a relatively significant motion has occurred). If it is determined in step 410 that the change is not greater than the threshold, the method moves to step 412 (described below).

If it is determined in step 410 that the change is greater than the threshold, in step 414, digital signal processor 104 outputs a motion flag through I/O interface 106, and the method moves to step 416. In step 416, digital signal processor 104 updates the reference frame by replacing the current reference frame stored in memory 108 with the sample frame captured in step 404. Thus, the sample frame captured in step 404 becomes the next reference frame for the next iteration of method 400.

In step 412, motion detector 100 returns to the sleep mode. In step 408, motion detector pauses or delays for a period of time before capturing the next sample frame. In one embodiment, the delay period is slightly less than one second (e.g., about nine tenths of a second). The method then returns to step 402, and the process is repeated.

In the embodiment shown in FIG. 4 and described above, the reference frame is updated (in step 416) only if it is determined in step 410 that the change between frames is greater than the threshold. If it is determined in step 410 that the change between frames is not greater than the threshold, the previously used reference frame remains the reference frame for the next iteration of method 400 (and possibly several iterations of method 400). In one embodiment, the same reference frame is used until the differences between the current sample frame and the reference frame are greater than the threshold. Thus, since there will typically be multiple sample frames captured before the reference frame is updated, the frames that are compared in step 406 will typically be non-successive frames.

To detect slower motions using successive images, a relatively small threshold of change should be used. However, the use of a smaller threshold is more likely to result in undesirable motion reports caused by insignificant events, and correspondingly additional power consumption. By using non-successive images, a higher threshold of change can be used, resulting in fewer false motion alarms, less power consumption, and significant changes in the scene can be detected, even if the motion occurs very slowly.

In the illustrated embodiment of method 400, a single event is sufficient to trigger a motion flag. In other words, any time that it is determined in step 410 that the change between frames is greater than the threshold, a motion flag is generated. In another embodiment of method 400, two or more such events are required before a motion flag is generated, which helps to prevent false motion alarms from being generated from changes in illumination, such as the sun rising or setting.

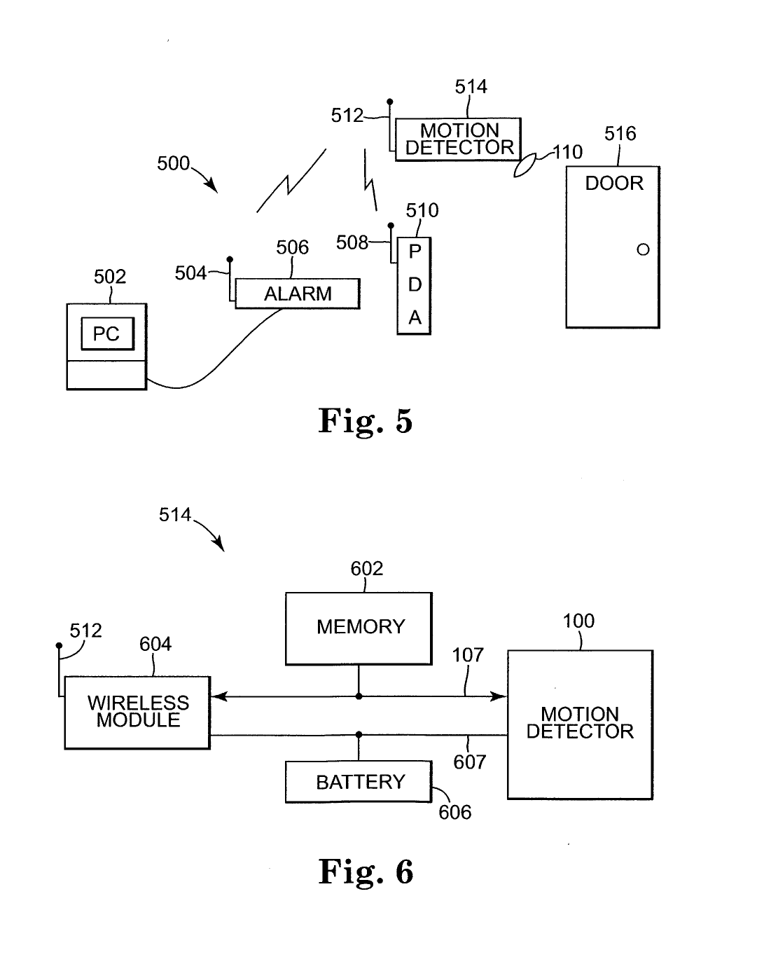

FIGS. 5-14 are diagrams illustrating various applications of low power motion detector 100 according to embodiments of the present invention. FIG. 5 is a block diagram illustrating a low power, wireless event detection system 500 according to one embodiment of the present invention. System 500 includes personal computer (PC) 502, alarm generator 506, personal digital assistant (PDA) 510, and wireless motion detector 514. As shown in FIG. 5, alarm generator 506, personal digital assistant 510, and wireless motion detector 514 include antennae 504, 508, and 512, respectively, for wireless communications with each other. In one embodiment, alarm generator 506 is connected to personal computer 502 via a wired connection for communications therewith. In another embodiment, alarm generator 506 is a stand-alone unit, and is not connected to a personal computer.

As shown in FIG. 5, lens 110 of wireless motion detector 514 is pointed towards a scene that includes a door 516. In one form of the invention, wireless motion detector 514 is configured to detect motion, such as the opening or closing of door 516, and wirelessly broadcast a motion detection signal via antenna 512 when motion is detected. The motion detection signal that is broadcast by detector 514 is received by alarm generator 506 via antenna 504, and by personal digital assistant 510 via antenna 508. In one embodiment, when alarm generator 506 receives a motion detection signal, alarm generator 506 outputs an audible and/or visible alarm signal to indicate that motion has been detected. Alarm generator 506 also outputs a signal to personal computer 502 that indicates that motion has been detected. In one embodiment, personal computer 502 is configured to keep track of motion detection statistics, such as dates, times, and locations of detected motion.

In one embodiment, when personal digital assistant 510 receives a motion detection signal from wireless motion detector 514, personal digital assistant 510 outputs an audible and/or visible alarm signal to indicate that motion has been detected. In one form of the invention, personal digital assistant 510 is configured to keep track of motion detection statistics, such as dates, times, and locations of detected motion. In one embodiment, wireless motion detector 514 is configured to be wirelessly programmed from personal digital assistant 510, alarm generator 506, and/or personal computer 502.

FIG. 6 is a block diagram illustrating major components of the wireless motion detector 514 shown in FIG. 5 according to one embodiment of the present invention. Wireless motion detector 514 includes antenna 512, wireless communication module 604, memory 602, battery 606, and motion detector 100. Wireless communication module 604 and motion detector 100 are coupled to each other, and to memory 602, via communication link 107. Wireless communication module 604 and motion detector 100 are powered by battery 606 via power line 607. In one embodiment, wireless communication module 604 is based on the Blue Tooth wireless communication protocol. In another embodiment, wireless communication module 604 is based on another wireless communication protocol, such as IEEE 802.11 (b), HomeRF, or other protocol. In one embodiment, memory 602 includes one or more programmable registers for controlling the configuration of motion detector 100.

In one embodiment, motion detector 100 captures and compares images as described above to determine whether motion has occurred, and outputs a motion flag to wireless module 604 when motion is detected. In one form of the invention, when motion detector 100 detects motion, detector 100 also outputs one or more captured images to wireless module 604.

Wireless communication module 604 wirelessly broadcasts motion flags and images received from motion detector 100 via antenna 512. Wireless communication module 604 also receives configuration information from personal digital assistant 510, alarm generator 506, and/or personal computer 502. Wireless communication module 604 programs memory 602 based on the received configuration information. In one embodiment, motion detector 100 includes several programmable options that may be set or modified by changing the contents of the registers in memory 602. Such programmable options according to one embodiment include the frame rate, the thresholds used for determining whether an event has occurred, zoning or masking out areas of the scene that are not of interest, as well as other options. The images wirelessly transmitted by wireless motion detector 514 and received by personal computer 502 and personal digital assistant 510 allow a user to remotely view a scene from the perspective of wireless motion detector 514. This remote viewing feature assists the user in accurately configuring the detector 514, and allows a user to view images of detected events. In one embodiment, wireless communication module 604 operates primarily in a sleep mode, and is configured to wake up about once per second, thereby conserving battery power.

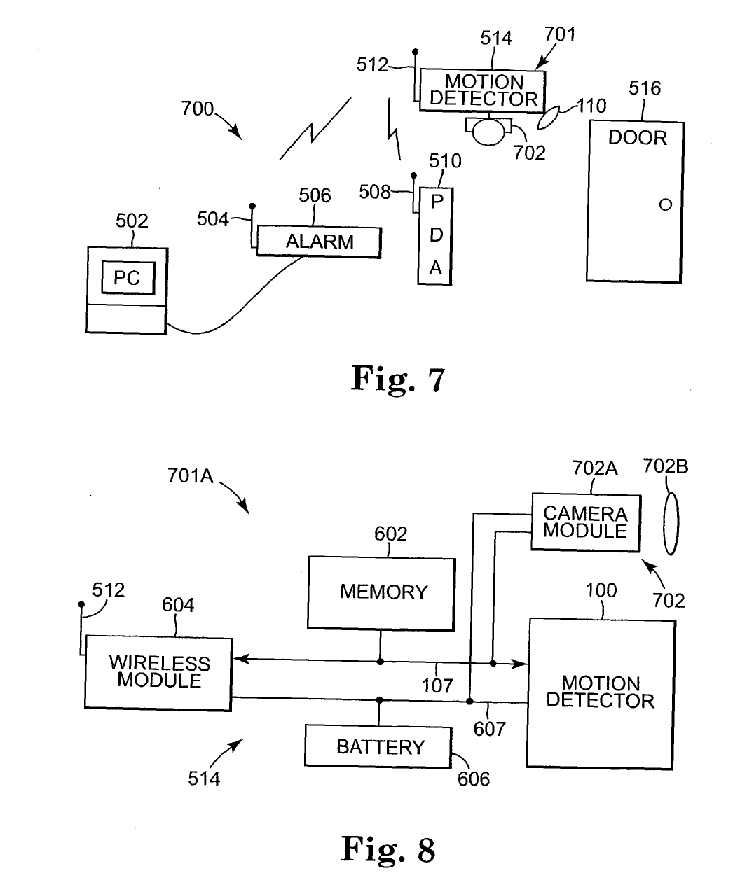

FIG. 7 is a block diagram illustrating a low power, wireless event detection and camera system 700 according to one embodiment of the present invention. The illustrated embodiment of system 700 is the same as system 500 (FIG. 5), with the exception that a camera 702 has been added. The combination of wireless motion detector 514 and camera 702 is referred to herein as wireless motion detection and camera system 701.

In one form of the invention, camera 702 is normally off to conserve power. Wireless motion detector 514 detects when motion occurs, and turns on camera 702 to record high-resolution images of the event that triggered the motion detection. In one embodiment, camera 702 includes a high-resolution complimentary metal oxide semiconductor (CMOS) image sensor with hundreds of thousands, or millions of pixels, (e.g., a 640×480 pixel sensor). In another embodiment, the high-resolution CMOS image sensor of camera 702 is implemented with a plurality of lower resolution CMOS image sensors.

In one embodiment, after turning on camera 702, if motion detector 514 does not generate another motion flag within a predetermined period of time, motion detector 514 sends a control signal to camera 702, causing camera 702 to be powered off.

FIGS. 8-10 are diagrams illustrating three embodiments of the wireless motion detection and camera system 701 shown in FIG. 7. The three embodiments shown in FIG. 8-10 are identified with the reference numbers 701A, 701B, and 701C, respectively.

FIG. 8 is a block diagram illustrating major components of the wireless motion detection and camera system 701 shown in FIG. 7 according to one embodiment of the present invention. System 701A includes wireless motion detector 514 and camera 702. Wireless motion detector 514 includes antenna 512, wireless communication module 604, memory 602, battery 606, and motion detector 100, which are configured in the same manner as illustrated in FIG. 6 and described above. Camera 702 includes camera module 702A and an associated lens 702B. Camera module 702A is powered by battery 606 via power line 607, and is coupled to communication link 107 for communications with wireless communication module 604, memory 602, and motion detector 100.

Lens 702B directs optical images onto camera module 702A. In one embodiment, when camera 702 is powered on by motion detector 100, camera module 702A generates high-resolution digital images based on the received optical images, and transmits the digital images to memory 602, where the images are stored. By turning on camera 702 only when there is activity, as is done in one form of the invention, power consumption is reduced, and less recording space is consumed, making the stored images easier to search.

In one form of the invention, when motion is detected by motion detector 100 and camera 702 is powered on, camera module 702A transmits high-resolution digital images to wireless communication module 604, which wirelessly transmits the images. The transmitted images can be received and viewed via the personal computer 502, personal digital assistant 510, or the images may be transmitted to another destination, such as to a security company, the local police, a cellular telephone, or other destination.

In one form of the invention, the images captured by camera module 702A are locally processed by system 701A to determine whether the images show a significant event (e.g., a person, a broken glass, etc.), and such captured images are only transmitted via communication module 604 if the images show a significant event.

In one embodiment, the motion flags and images wirelessly transmitted by system 701A are received by an existing communications infrastructure (e.g., cellular telephone network, WiFi or wired network, pager network, or some other existing communications infrastructure, or any combination of these), which forwards the information to a user's receiving device 502 and/or 510 (e.g., a portable electronic device such as a pager, cellular telephone, personal digital assistant, or special-purpose receiver, or a non-portable device, such as a personal computer or special security workstation). In another embodiment, the motion flags and images wirelessly transmitted by system 701A are received by a base station unit 506, which transmits the information to an existing communications infrastructure, which in turn forwards the information to a user's receiving device 502 and/or 510. In one embodiment, the motion flags wirelessly transmitted by system 701A include image data based on images captured by motion detector 100 and/or camera module 702A.

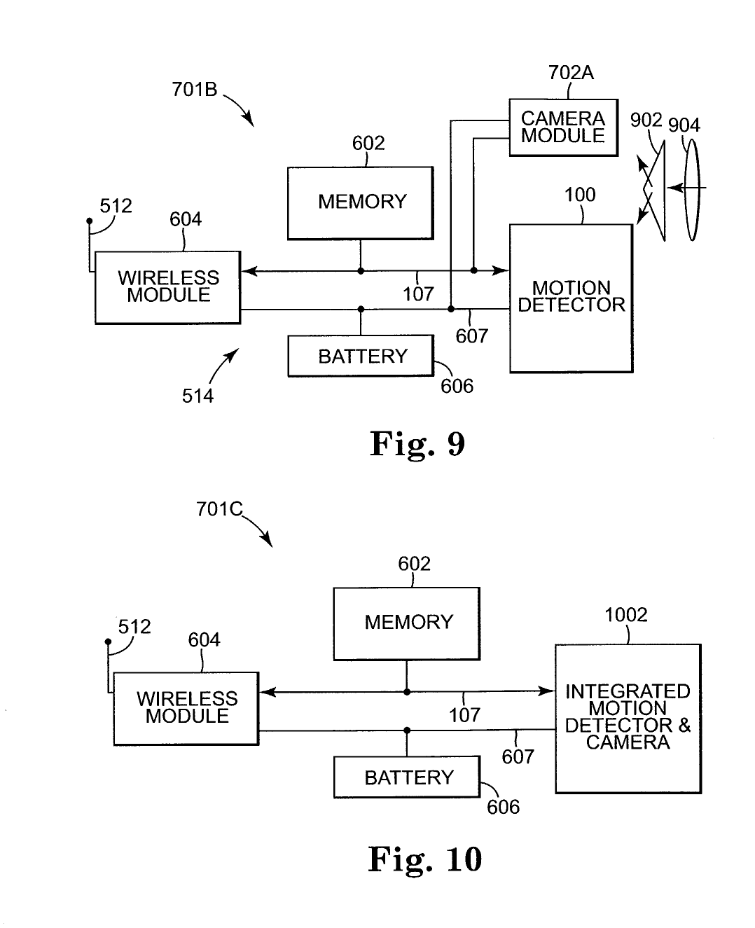

FIG. 9 is a block diagram illustrating major components of the wireless motion detection and camera system 701 shown in FIG. 7 according to a second embodiment of the present invention. System 701B includes wireless motion detector 514 and camera module 702A. Wireless motion detector 514 includes antenna 512, wireless communication module 604, memory 602, battery 606, and motion detector 100, which are configured in the same manner as illustrated in FIG. 6 and described above. Camera module 702A is configured in the same manner as shown in FIG. 8 and described above.

As shown in FIG. 9, rather than providing a separate lens for camera module 702A and motion detector 100, system 701B uses a single lens 904 and an optical splitter 902. Optical images are directed by lens 904 onto optical splitter 902, which directs the images onto both the camera module 702A and the motion detector 100. Camera module 702A and motion detector 100 capture and digitize the optical images in the same manner as described above.

FIG. 10 is a block diagram illustrating major components of the wireless motion detection and camera system 701 shown in FIG. 7 according to a third embodiment of the present invention. System 701C includes antenna 512, wireless communication module 604, memory 602, and battery 606, which are configured in the same manner as illustrated in FIG. 6 and described above. System 701C also includes integrated motion detector and camera device 1002. Device 1002 combines the functions of camera module 702A and motion detector 100 into a single integrated device. In one embodiment, device 1002 is configured in substantially the same manner as shown in FIGS. 1 and 2, but pixel array 200 (FIG. 2) is a high-resolution array (e.g., 640×480 pixels), and only a subset of the array 200 (e.g., 16×16 pixels) is used for motion detection. The remaining pixels of the array 200 are powered-down until motion is detected. When motion is detected, the entire array 200 is powered-up and used to capture high-resolution images of the event that triggered the motion detection.

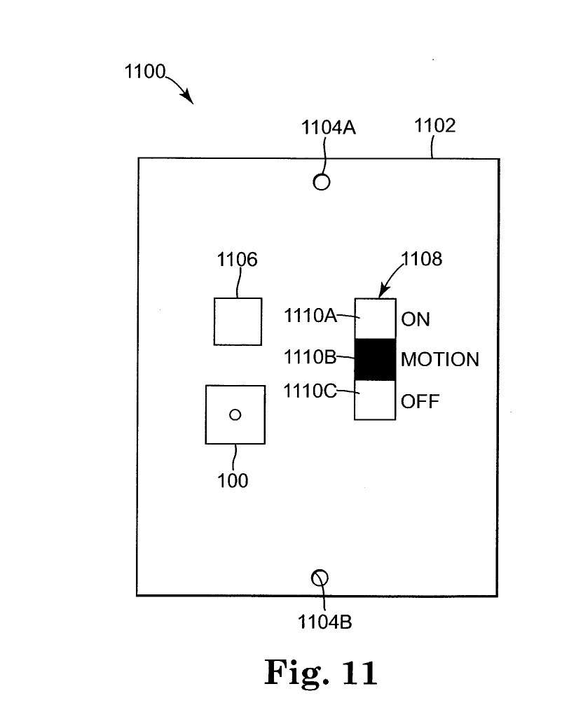

FIG. 11 is a diagram illustrating a motion detecting control switch apparatus 1100 according to one embodiment of the present invention. Switch apparatus 1100 includes mounting plate 1102, screw holes 1104A and 1104B, pushbutton switch 1106, three-position switch 1108, and motion detector 100. Switch apparatus 1100 may be used to control the power state of virtually any type of device, such as a light, computer, air conditioning unit, or other device. For the sake of simplifying the description, switch apparatus 1100 will be described in the context of controlling a light.

Switch apparatus 1100 may be mounted on a wall by inserting screws threw holes 1104A and 1104B, and into the wall. Switch 1108 includes positions 1110A, 1110B, and 1110C. Position 1110A corresponds to an “on” state, and causes the light coupled to switch apparatus 1100 to be turned on. Position 1110C corresponds to an “off” state, and causes the light coupled to switch apparatus 1100 to be turned off. Position 1110B corresponds to a “motion” state, in which the power state of the light coupled to switch apparatus 1100 is controlled by pushbutton switch 1106 and motion detector 100. In one embodiment, when switch 1108 is in the “motion” position 1110B, the light coupled to switch apparatus 1100 is automatically turned on when motion is detected by motion detector 100, and may also be manually turned on and off by pushing pushbutton switch 1106.

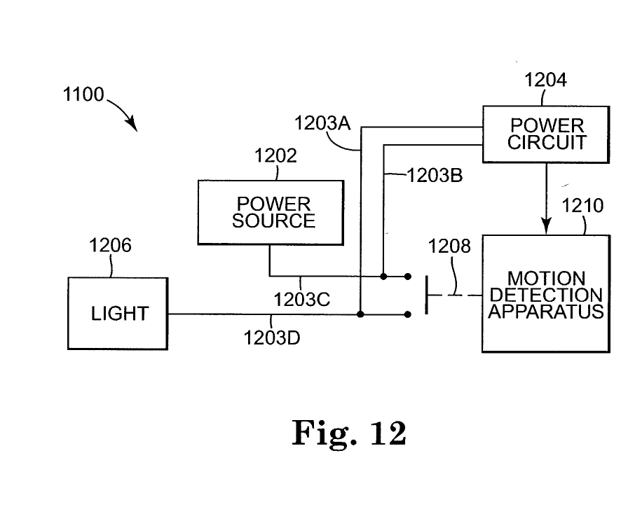

FIG. 12 is a block diagram illustrating major components of the control switch apparatus 1100 shown in FIG. 11 according to one embodiment of the present invention. Control switch apparatus 1100 includes power circuit 1204 and motion detection apparatus 1210. Power source 1202 provides power for the light 1206 being controlled, the power circuit 1204, and the motion detection apparatus 1210. In one embodiment, power source 1202 is the Mains power supply. Power source 1202 provides power on power line 1203C. Power line 1203C is coupled to power line 1203B, which provides power to power circuit 1204. Power circuit 1204 provides power to motion detector 1210, and also selectively provides power to light 1206 via power lines 1203A and 1203D when a user manually turns light 1206 on with switch 1106 or 1108 (FIG. 11).

Motion detection apparatus 1210 is configured to detect motion based on captured images as described above with reference to FIGS. 1 and 2. When motion detection apparatus 1210 detects motion, apparatus 1210 triggers switch (relay) 1208, causing power lines 1203C and 1203D to be connected together, thereby providing power to light 1206.

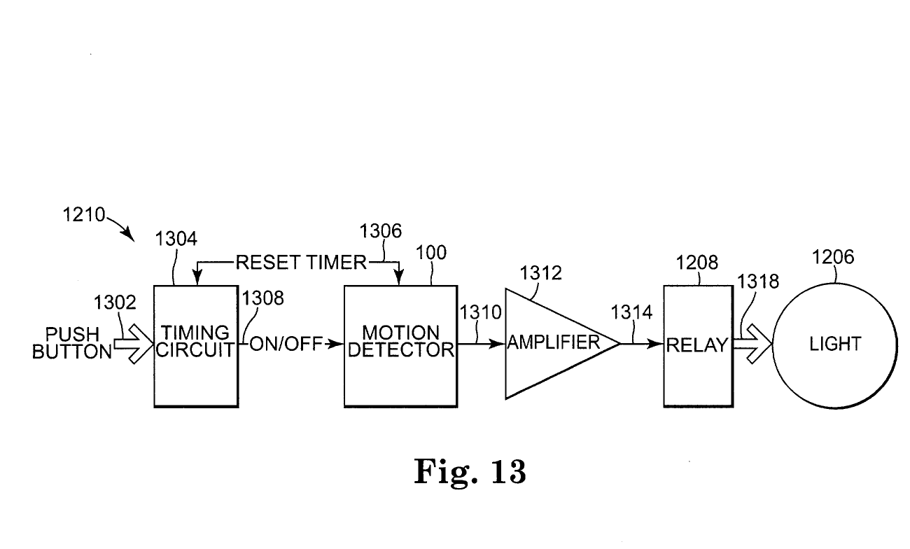

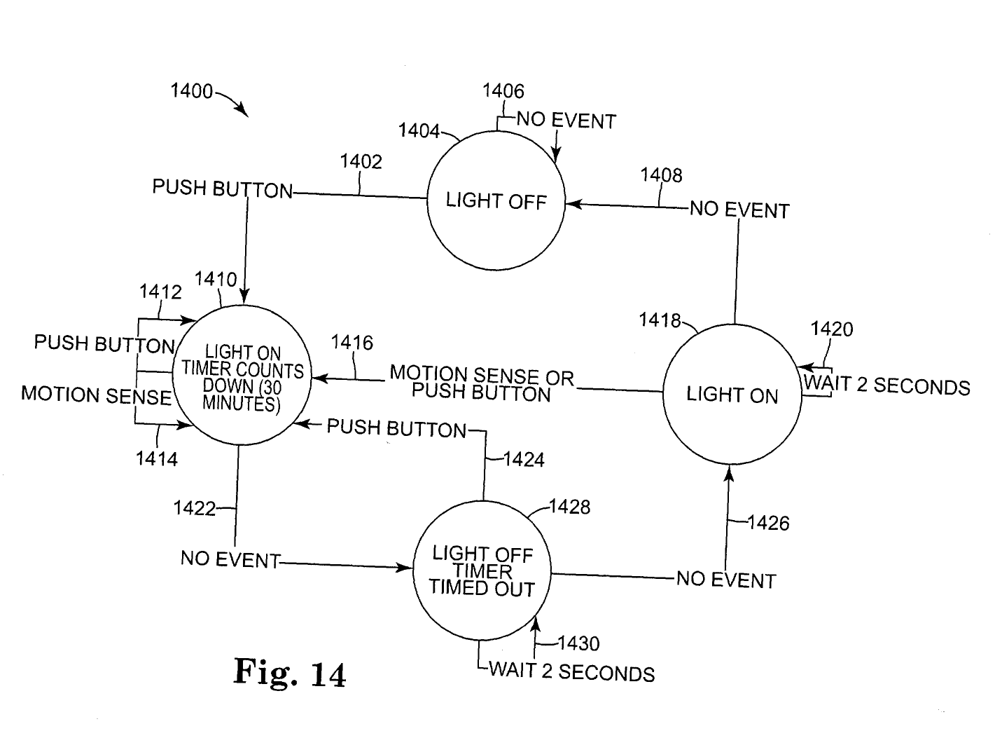

FIG. 13 is a block diagram illustrating major components of the motion detection apparatus 1210 shown in FIG. 12 according to one embodiment of the present invention. Motion detection apparatus 1210 includes timing circuit 1304, motion detector 100, and amplifier 1312. Timing circuit 1304 includes input 1302, which is coupled to pushbutton switch 1106 (FIG. 11). Timing circuit 1304 outputs on/off light control signals 1308 to motion detector 100, and receives timer reset signals 1306 from motion detector 100. In one embodiment, timing circuit 1304 is configured to perform a thirty-minute countdown, and a two-second countdown, as described in further detail below with reference to FIG. 14. In other embodiments, other values for the countdowns may be used.

In one form of the invention, when timing circuit 1304 is performing a thirty-minute countdown and motion detector 100 detects motion, motion detector 100 outputs a timer reset signal 1306 to timing circuit 1304, causing the thirty-minute countdown to be reset.

In one embodiment, motion detector 100 is configured to output power control signals via communication link 1310 when motion detector 100 detects motion, or when motion detector 100 receives an on/off light control signal 1308 from timing circuit 1304. The power control signals are amplified by amplifier 1312, and output to relay 1208 via communication link 1314. The power control signals received by relay 1208 cause relay 1208 to change the power state of light 1206 (i.e., turn light 1206 on if it is currently off, or turn light 1206 off if it is currently on).

FIG. 14 is a flow diagram illustrating a method 1400 for controlling a light 1206 with the control switch apparatus 1100 shown in FIG. 11 according to one embodiment of the present invention. The method 1400 begins at step 1404, where light 1206 is in the off state. As indicated by step 1406, light 1206 remains in the off state as long as no event is detected. In step 1402, pushbutton switch 1106 is pressed, and the method moves to step 1410. In step 1410, light 1206 is turned on, and timing circuit 1304 begins a thirty-minute countdown. In one embodiment, timing circuit 1304 senses the push of pushbutton switch 1106 via input 1302, outputs an on/off light control signal 1308 to motion detector 100, which outputs a power control signal via communication link 1310 that causes light 1206 to be powered.

In step 1412, if pushbutton switch 1106 is pressed during the thirty-minute countdown, light 1206 remains on, and timing circuit 1304 resets the thirty-minute countdown. In step 1414, if motion is detected by motion detector 100 during the thirty-minute countdown, light 1206 remains on, and motion detector 100 outputs a timer reset signal 1306 to timing circuit 1304, causing the thirty-minute countdown to be reset. Thus, light 1206 remains on as long as motion is detected, or pushbutton switch 1106 is pushed, at least once every thirty-minutes. If pushbutton switch 1106 is not pressed or no motion is detected when the thirty-minute countdown expires, a no event condition is entered, as indicated by step 1422, and the method moves to step 1428.

In step 1428, light 1206 is turned off. In one embodiment, when the thirty-minute countdown expires, timing circuit 1304 outputs an on/off light control signal 1308 to motion detector 100, which outputs a power control signal via communication link 1310 that causes light 1206 to be powered off. As indicated by step 1430, light 1206 remains off for a two-second period, which is counted down by timing circuit 1304. In step 1424, if the pushbutton switch 1106 is pushed during the two-second period, the method moves back to step 1410, where the light 1206 is turned back on and the thirty-minute countdown is reset. If the pushbutton switch 1106 is not pushed during the two-second period, a no event condition is entered, as indicated by step 1426, and the method moves to step 1418.

In step 1418, light 1206 is turned on. In one embodiment, when the two-second countdown expires, timing circuit 1304 outputs an on/off light control signal 1308 to motion detector 100, which outputs a power control signal via communication link 1310 that causes light 1206 to be powered on. As indicated by step 1420, light 1206 remains on for a two-second period, which is counted down by timing circuit 1304. In step 1416, if pushbutton switch 1106 is pressed or if motion is detected during the two-second period, the method returns to step 1410, where light 1206 remains on, and the thirty-minute countdown is reset. If pushbutton switch 1106 is not pressed or no motion is detected within the two second period, a no event condition is entered, as indicated by step 1408, and the method returns to step 1404, where the light 1206 is turned off. So if a person is in the room with light 1206, and the person is not moving, the light 1206 turns off after thirty minutes, then flashes on for two seconds, allowing the individual to wave his arm or otherwise signal to the motion detector 100 to cause the light to remain on for at least another thirty minutes.

One form of the present invention provides a low power, low cost, motion detector that is less expensive and consumes less power than existing motion detectors. In one embodiment, the motion detector is based on an Agilent ADNS 2020 image sensor chip operated primarily in a low power sleep mode, and consumes about 500 microamps at 3.3 volts (1.5 milliwatts), thereby providing about 386 hours of usage using a 9-volt cell, or about 11,400 hours of usage using two battery “D” cells. In one form of the invention, the low power motion detector can be optimized for a particular application to further reduce the power consumption, and provide up to about five years or more of usage from two battery “D” cells. For example, the number of gates in the image sensor chip can be reduced, and the sleep time can be increased, to further reduce power consumption.

The image sensor (e.g., ADNS 2020) used in the motion detector according to one aspect of the invention uses only a limited amount of supporting hardware (e.g., inexpensive optical lens, batteries, circuit board, and housing), thereby providing a low cost motion detecting solution. In one embodiment, the motion detector is implemented via a very small module. In one form of the invention, the motion detector module is about 30×50×30 millimeters in size. In addition, the motion detector used in one embodiment of the present invention provides better detection of smaller scene details than a typical PIR motion detector.

One form of the present invention provides a motion detecting security camera system that consumes a relatively small amount of power, and that captures high-resolution images. The security camera system of one form of the invention uses relatively low-cost and low power consumption CMOS image sensors. The camera system of one embodiment of the present invention is battery powered. One form of the present invention provides a camera system with more power savings than prior art camera systems. The power savings provided by embodiments of the present invention provide for longer battery life, and/or the ability to use smaller batteries.

Although specific embodiments have been illustrated and described herein for purposes of description of the preferred embodiment, it will be appreciated by those of ordinary skill in the art that a wide variety of alternate and/or equivalent implementations may be substituted for the specific embodiments shown and described without departing from the scope of the present invention. Those with skill in the mechanical, electro-mechanical, electrical, and computer arts will readily appreciate that the present invention may be implemented in a very wide variety of embodiments. This application is intended to cover any adaptations or variations of the preferred embodiments discussed herein. Therefore, it is manifestly intended that this invention be limited only by the claims and the equivalents thereof.

What is claimed is:

1. A low power motion detection system, comprising:
a low-resolution image sensor having a normal mode and a low power consumption sleep mode, the sensor configured to periodically exit the sleep mode and enter the normal mode, capture a low-resolution image of a scene in the normal mode, and then return to the sleep mode; and
a controller for determining whether motion has occurred based on images captured by the sensor.

2. The motion detection system of claim 1, wherein the motion detection system is battery-powered.

3. The motion detection system of claim 1, and further comprising:
a high-resolution camera coupled to the controller; and
wherein the controller is configured to power on the camera when the controller detects motion, thereby causing the camera to capture high-resolution images of the scene.

4. The motion detection system of claim 3, wherein the controller is configured to power off the camera.

5. The motion detection system of claim 3, and further comprising:
a wireless communication module coupled to the camera for wirelessly transmitting the captured high-resolution images.

6. The motion detection system of claim 1, and further comprising:
a first wireless communication module coupled to the controller for wirelessly transmitting a motion detection signal when motion is detected by the controller.

7. The motion detection system of claim 6, wherein the motion detection signal contains data representing an image.

8. The motion detection system of claim 6, and further comprising:
a second wireless communication module configured to receive the motion detection signal.

9. The motion detection system of claim 8, and further comprising:
an alarm generator coupled to the second wireless communication module for generating an alarm indication when the motion detection signal is received.

10. The motion detection system of claim 8, wherein the second wireless communication module is implemented in a portable electronic device, the portable electronic device configured to generate an alarm indication when the motion detection signal is received.

11. The motion detection system of claim 10, wherein the image sensor is configured to be wirelessly programmed from the portable electronic device.

12. The motion detection system of claim 1, wherein the image sensor is configured to periodically enter the normal mode and capture a low-resolution image of the scene at a rate of about once per second.

13. A method of detecting motion, comprising:
(a) providing a low-resolution image sensor having a normal mode and a low power consumption sleep mode;
(b) switching from the sleep mode to the normal mode;
(c) capturing a sample frame of a scene with the image sensor in the normal mode;
(d) determining whether motion has occurred based on the sample frame and a previously captured reference frame; and
(e) switching from the normal mode to the sleep mode.

14. The method of claim 13, and further comprising:
(f) periodically repeating steps (b) through (e).

15. The method of claim 14, wherein steps (b) through (e) are repeated at a rate of about once per second.

16. The method of claim 13, wherein the sample frame and the reference frame are successively captured images.

17. The method of claim 13, wherein the sample frame and the reference frame are non-successively captured images.

18. A method of detecting motion with an image sensor, comprising:
(a) capturing a sample frame of a scene with the image sensor;
(b) identifying a difference between the sample frame and a current reference frame of the scene;
(c) identifying whether the difference is greater than a threshold value;
(d) generating a motion detection indication if the difference is greater than the threshold;
(e) replacing the current reference frame with the sample frame only if the difference is greater than the threshold, thereby making the sample frame the current reference frame; and
(f) periodically repeating steps (a) through (e).

19. A motion detecting control switch apparatus for controlling a power state of a device, the switch comprising:
a motion sensor for capturing images of a scene and detecting motion based on the captured images; and
a first user input device for selecting an on state, an off state, and a motion state, wherein selection of the on state causes the device to be powered on, selection of the off state causes the device to be powered off, and selection of the motion state causes the power state of the device to be controlled by the motion sensor.

20. The switch apparatus of claim 19, and further comprising:
a second user input device for manually controlling the power state of the device when the motion state is selected.

21. The switch apparatus of claim 19, and further comprising:
a timing circuit for causing the device to be powered off if no motion is detected by the motion sensor for a predetermined period of time.
